(19) United States
(12) Patent Application Publication
(10) Pub. No.: US 2025/0261131 A1
(43) Pub. Date: Aug. 14, 2025

(54) PERIODIC POWER HEADROOM REPORT FOR UPLINK CARRIER AGGREGATION

(71) Applicant: QUALCOMM Incorporated, San Diego, CA (US)

(72) Inventors: Peng LIU, Xi'an (CN); Zhiliang ZHENG, Beijing (CN); Ling XIE, Beijing (CN); Peng WU, Shanghai (CN); Tom CHIN, San Diego, CA (US)

(21) Appl. No.: 18/857,175

(22) PCT Filed: May 10, 2022
(86) PCT No.: PCT/CN2022/091925

§ 371 Date: Oct. 15, 2024

(51) Int. Cl. H04W 52/36; H04W 72/0446; H04W 72/1268

(52) U.S. Cl. CPC H04W 52/365; H04W 72/0446; H04W 72/1268

(57) ABSTRACT

Certain aspects of the present disclosure provide a method for wireless communications by a user equipment (UE). The method generally includes waiting for a multiple component carrier (multi-CC) uplink slot in which an uplink slot on a first component carrier (CC) overlaps with an uplink slot of a second CC in order to transmit a periodic power headroom report (PHR) in a current PHR period and transmitting, in the multi-CC uplink slot, the periodic PHR with power headroom (PH) values for the first CC and the second CC.

### BACKGROUND

### Field of the Disclosure

Aspects of the present disclosure relate to wireless communications, and more particularly, to techniques for power headroom reporting for uplink carrier aggregation.

### Description of Related Art

Wireless communications systems are widely deployed to provide various telecommunications services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE), including waiting for a multiple component carrier (mule-CC) uplink slot in which an uplink slot on a first component carrier (CC) overlaps with an uplink slot of a second CC in order to transmit a periodic power headroom report (PHR) in a current PHR period; and transmitting, in the multi-CC uplink slot, the periodic PHR with power headroom (PH) values for the first CC and the second CC.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example time division duplex (TDD) slot configuration.

FIGS. 6A and 6B depict examples of real and virtual power headroom report (PHR) and a corresponding medium access control (MAC) control element.

FIG. 7 depicts a potential issue with PHR in carrier aggregation (CA) including primary component carrier (PCC) and secondary component carrier (SCC).

FIG. 8 depicts a call flow diagram for PHR on a multiple component carrier (multi-CC) uplink slot, in accordance with aspects of the present disclosure.

FIG. 9 depicts an example timing diagram for PHR on a multi-CC uplink slot, in accordance with aspects of the present disclosure.

FIG. 10 depicts another example timing diagram for PHR on a multi-CC uplink slot, in accordance with aspects of the present disclosure.

FIG. 11 depicts a method for wireless communications.

FIG. 12 depicts aspects of an example communications device.

### DETAILED DESCRIPTION

Aspects of the present disclosure provide apparatuses, methods, processing systems, and computer-readable mediums for techniques that may help enhance power headroom reporting for uplink carrier aggregation (UL-CA).

In 5G NR, a power headroom report (PHR) is typically sent by a UE to a network entity to report the power headroom available at the UE. Power headroom (PH) generally indicates the difference between a maximum transmission power allowed by the UE and a current transmission power.

In some cases, values reported via a PHR may be used to make decisions on the network side. Such decisions may include whether or not to switch a type of waveform used for physical uplink shared channel (PUSCH) transmission. In 5GNR, PUSCH may be transmitted using a cyclic prefix orthogonal frequency division multiplexed (CP-OFDM) waveform or a discrete Fourier transform-spread orthogonal frequency-division multiplexing (DFT-s-OFDM) waveform. A switch from CP-OFDM to DFT-s-OFDM may reduce PAPR (Peak to Average Power Ratio) for better UL performance.

However, in 5G NR with uplink carrier aggregation (UL-CA) including primary component carrier (PCC) and secondary component carrier (SCC), there are certain potential challenges for accurate PH value reporting. For example, in UL-CA scenarios, if the PHR is reported only on a PCC uplink slot that is not overlapped with an SCC uplink slot, the SCCs reported PH value may always be a virtual PHR. This virtual PHR may have a PH value greater than zero and, thus, may prevent triggering a CP-OFDM to DFT-s-OFDM waveform switch and the resulting reduction in PAPR.

Aspects of the present disclosure, however, provide techniques that may help accurately report PHR in such scenarios, by waiting for a PCC uplink slot that overlaps with an SCC uplink slot. Such a slot were PCC and SCC uplink slots overlap may, thus, be referred to herein as a “2-CC slot” (in contrast to a 1-CC slot” wherein only one of the PCC or SCC is uplink). Waiting for a 2-CC slot may allow the UE to provide a robust PHR without ambiguity to assist in decisions, such as waveform switching.

Aspects of the present disclosure may lead to more accurate PH value reporting in UL-CA scenarios, allowing the triggering of waveform switching, when appropriate. As a result, the techniques presented herein may help reduce PAPR and overall UE power consumption.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

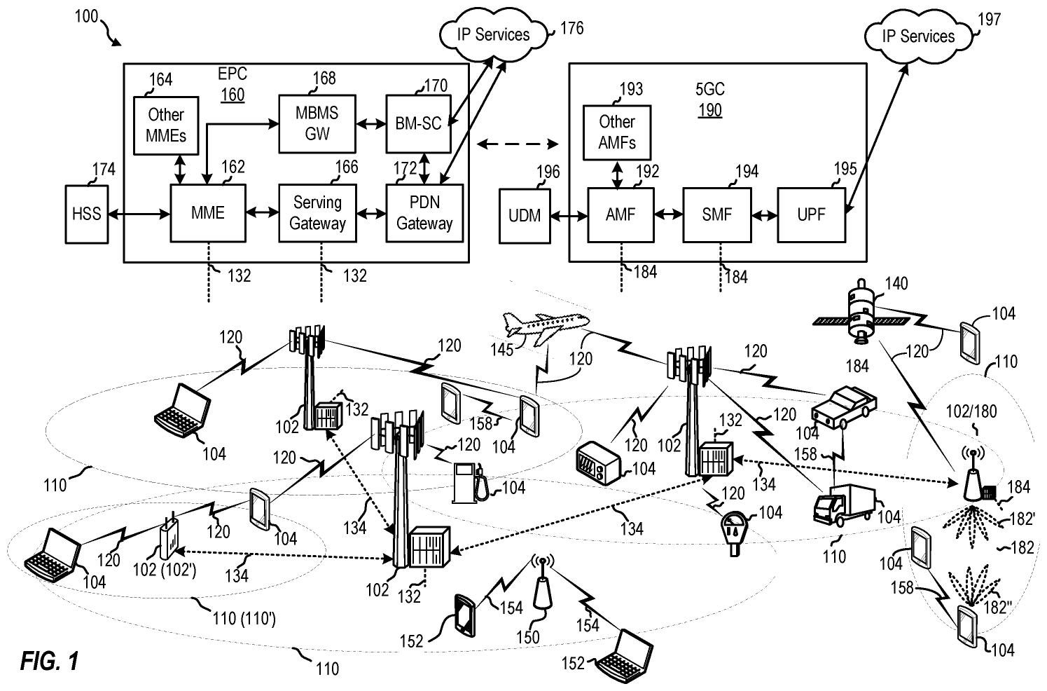

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

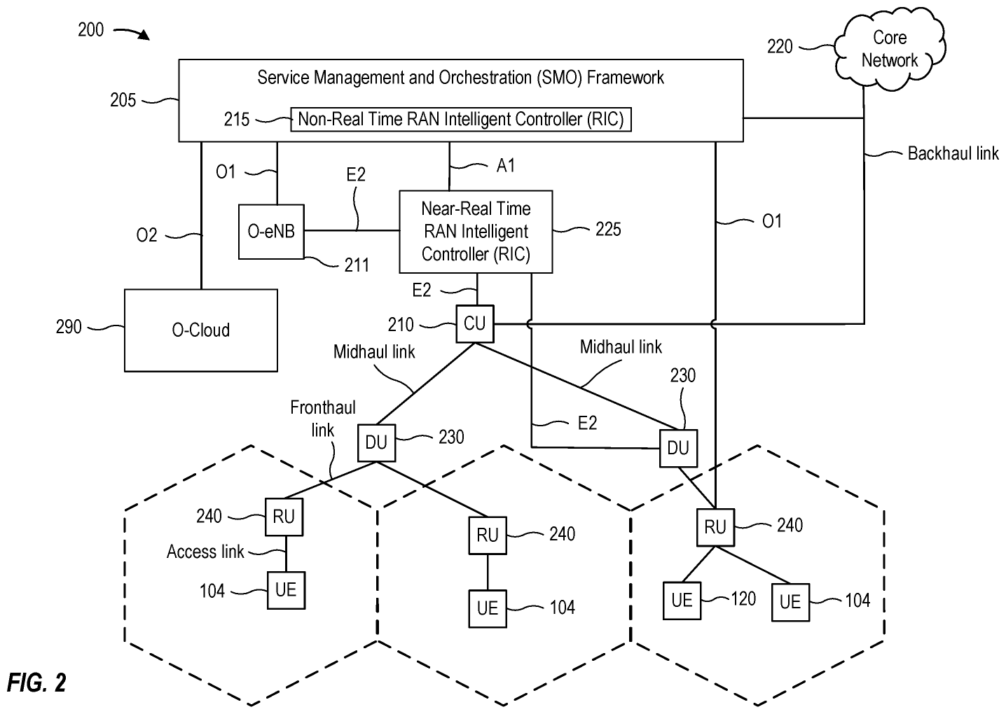

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. BS 180 may also receive the beamformed signal from UE 104 in one or more receive directions 182′. Base station 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units.

Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

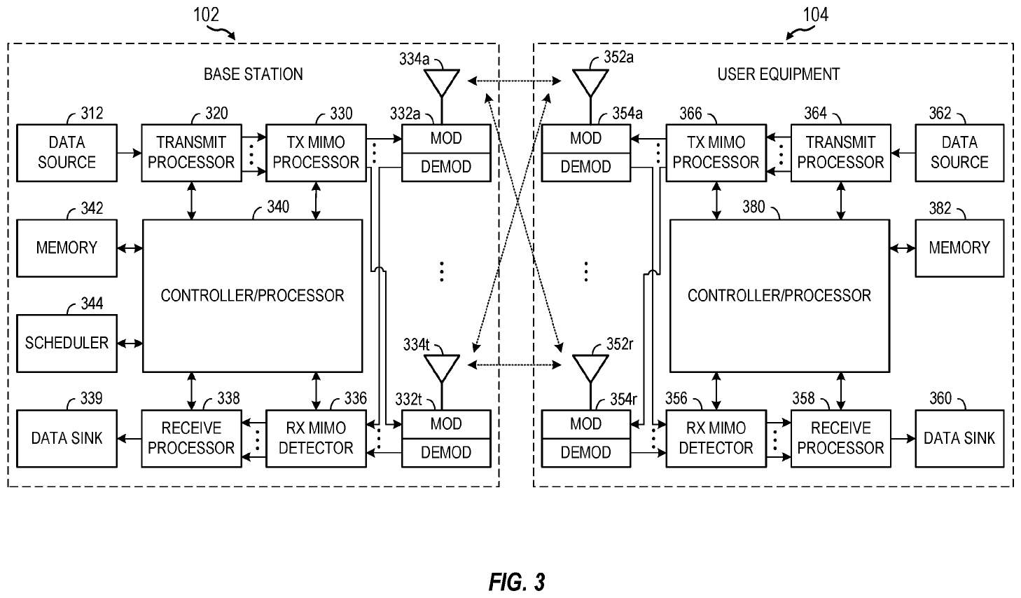

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)).

The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

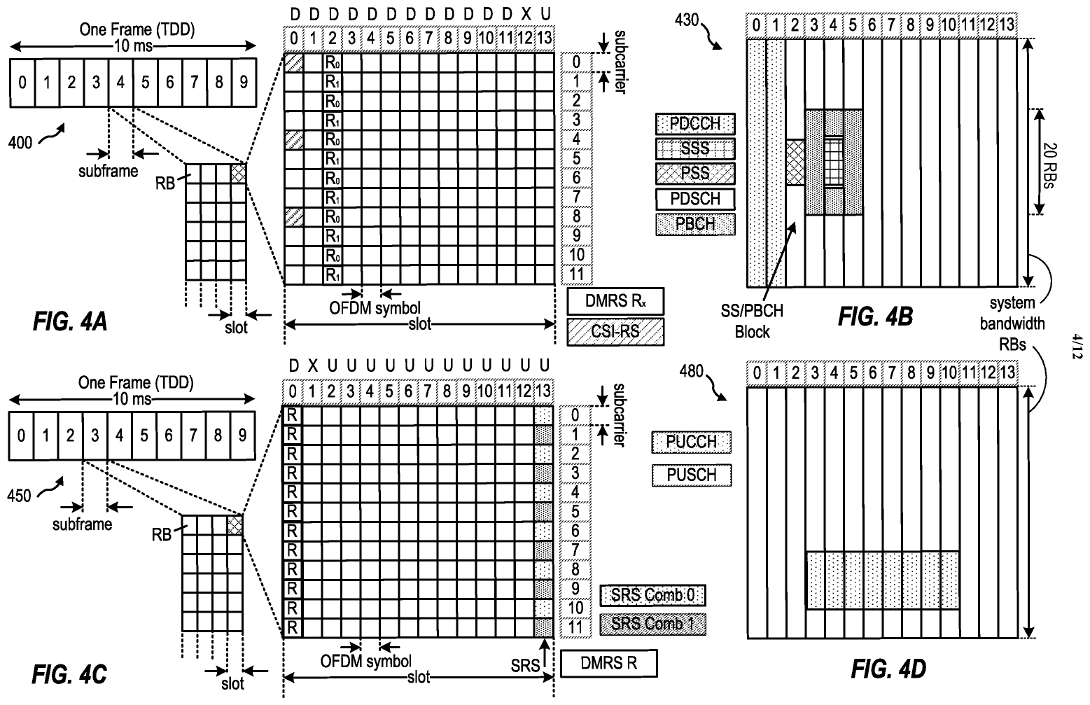

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2u slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Time Division Duplex (TDD) Slot Configuration

In 5G NR TDD slot configuration, each symbol within a slot can be scheduled as three transmission modes: (1) uplink (U), (2) downlink (D), and (3) Flexible (F). Flexible symbols generally refer to symbols that are not dedicated as either downlink or uplink, via a common TDD slot configuration. One goal of introducing the flexible symbols within a slot is to support guard period between uplink symbols and downlink symbols or between downlink symbols and uplink symbols. The number of orthogonal frequency division multiplexing (OFDM) symbols in a slot is fixed that is 14 with normal cyclic prefix (CP) or 12 with extended CP. If a slot is configured as uplink, all symbols in this slot are dedicated for uplink. If a slot is configured as downlink, all symbols are dedicated for downlink. In 5G NR TDD, it is possible that a slot may not be configured to be fully used for downlink or for uplink. A slot can also be classified as mixed uplink and downlink transmissions, wherein uplink and downlink symbols coexist.

Three general TDD configurations are supported in 5G NR that is (1) static TDD configuration, (2) semi-static TDD configuration, and (3) dynamic TDD configuration. In static TDD configuration, slots/symbols may be configured by a network as U, D, or F using cell-specific configuration (tdd-UL-DL-ConfigurationCommon). In semi-static TDD configuration, UE-specific configurations may be used to adjust the slot DL/UL configuration based on current UE needs. In such cases, the network may send a UE-specific slot configuration (e.g., using an IE tdd-UL-DL-ConfigurationDedicated) which modifies the flexible slots and symbols (as U or D). The cell-specific configuration for slots/symbols cannot be changed by UE-specific configuration. A dynamic TDD configuration can be achieved using download control information (DCI) format 2_0 scheduling, wherein a cyclic redundancy check (CRC) scrambled with radio network temporary identifier (SFI-RNTI) may be used to configure the slot format.

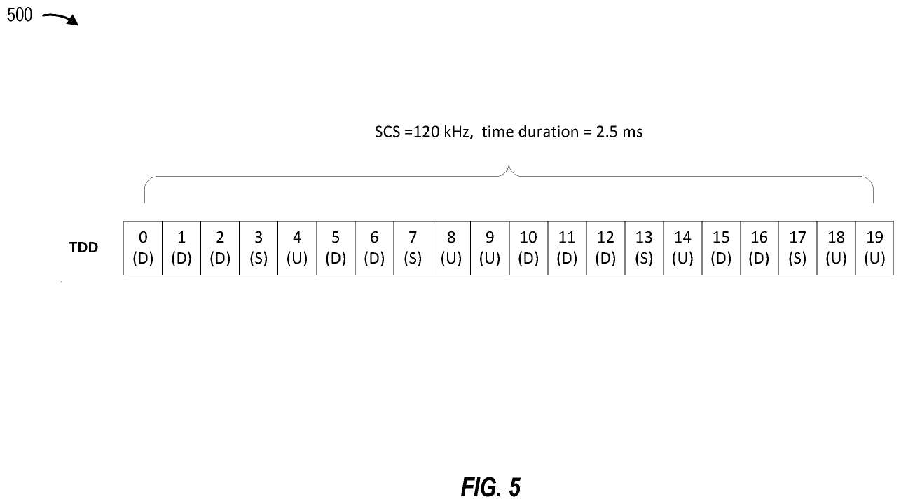

FIG. 5 shows an example slot configuration example 500 in 5G NR TDD. There are a total of 20 slots configured for uplink, downlink or mix uplink and downlink transmission. In this example, the sub carrier spacing (SCS) is 120 KHz, and transmission period is 2.5 ms. These two parameters can be setup by parameters ‘referenceSubcarrierSpacing’ and ‘dl-UL-TransmissionPeriodicity’ in a common TDD configuration (tdd-UL-DL-ConfigurationCommon). In this transmission period, the first 3 slots are configured for uplink and the last 2 slots are configured for downlink. Between downlink slots and uplink slots, several mixed uplink and downlink slots (e.g., slot 3, 7, 13, 17 as S) are configured to provide guard period, which is necessary for switching from downlink to uplink or from uplink to downlink.

### Overview of Power Headroom Report

UE battery life has a great impact on user experience, which is a key factor for satisfying different use cases in 5G NR including ultra-reliable and low latency communications (URLLC), massive machine type communications (mMTC), and enhanced mobile broadband (eMBB). To help extend battery life, a UE power headroom report (PHR) may be sent by UEs to the network for improving energy efficiency. The PHR indicates a value for power headroom (PH) available in the UE. As noted above, PH generally indicates the difference between the maximum transmission power allowed by UEs and the currently evaluated uplink transmission on physical uplink shared channel (PUSCH), which can be described by a formula:

$$PH = {P}_{max} - {P}_{pusch} ,$$

A negative PH value typically means a current PUSCH transmission power has exceeded the maximum allowed transmission power and the RB allocation can be reduced in the next scheduling. A positive PH value typically means the current PUSCH transmission power is below the allowed transmission power and the RB allocation can be maintained or increased. The value of PH is sent by the control unit of medium access control (MAC) layer, so MAC control unit related to this process is also called PHR control unit.

A UE typically determines whether to report a real or virtual PH value, based on timing of uplink scheduling. From the time when a PHR is triggered until the resources for PHR transmission are allocated, if there is PUSCH and sounding reference signal (SRS) transmission or other actual uplink transmission, a real PHR value may be reported. Otherwise, a virtual PHR value may be reported.

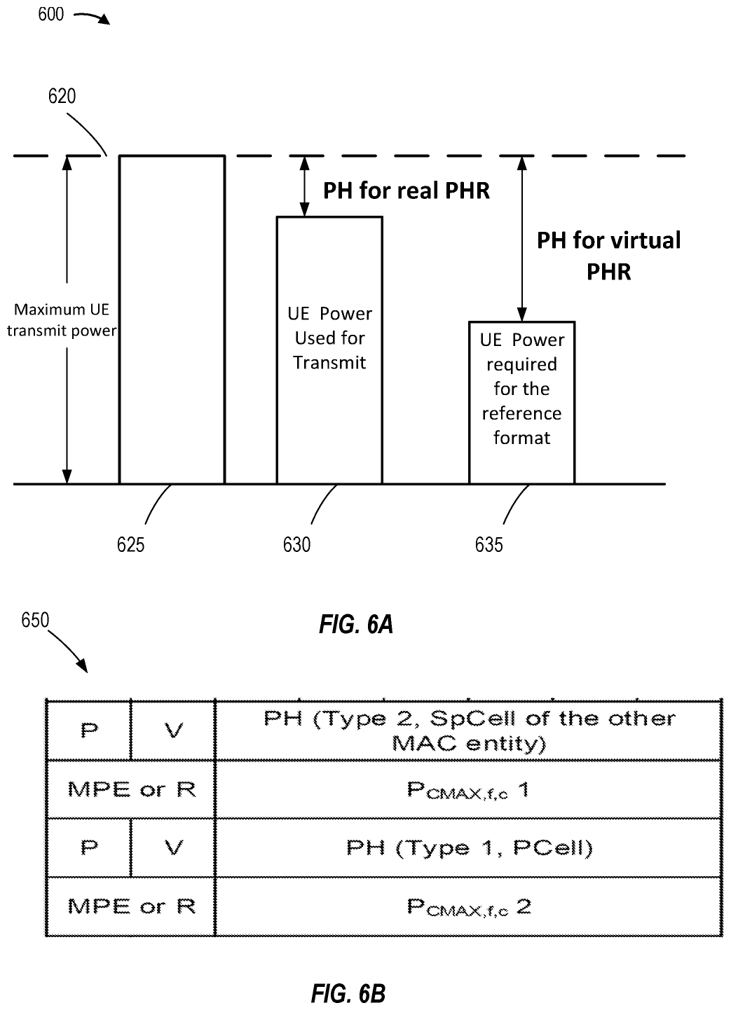

FIG. 6A shows examples of real and virtual PH values. When the value of PH is calculated between the maximum UE transmit power 625 and current uplink slot transmission power 630 (e.g., a scheduled PUSCH or sounding reference signal (SRS)), a real PH may be reported in the PHR. If there is no actual uplink transmission, a virtual value of PH may be reported based on the maximum UE transmit power 625 and a reference value 635.

FIG. 6B shows a MAC control element 650 which has five fields for each component carrier. The rightmost 6 bits of the first Octet for each component carrier indicates 64 levels from 0 to 63, each of which corresponds to a PH value range. The real PH value (in terms of dB) may be obtained by using the 6 bit value indicated in the MAC CE as an index into a power headroom report mapping table. In other words, the power headroom report mapping table maps each 6-bit PH value to a range such that, given the reported 6-bit value, the network can determine the range (in dB) of the PH quantity measured by the UE

### Overview of Carrier Aggregation

In order to meet the requirements of single-user peak rate and system capacity improvement, one of the most direct methods is to increase the system transmission bandwidth. To this end, carrier aggregation (CA) has been introduced in LTE-A and is commonly used in 5G NR to increase the bandwidth. Each aggregated carrier is referred to as a component carrier (CC). Based on the CA technology, several CCs can be aggregated together to achieve a maximum transmission bandwidth, effectively improving the uplink and downlink transmission rates. The UE can use up to several carriers for uplink and downlink transmission at the same time according to its own capability.

The primary serving cell camps the UE in CA, from which the UE is served by primary component carrier (PCC) that is complemented with one or several secondary component carriers (SCC). The PCC and SCC are relative to the UE, and for different UEs, the PCC and SCC may be different. Moreover, the multiple carriers participating in the aggregation are not limited to the same base station (BS), but may also come from adjacent base stations (BSs). All the control signaling are handled by the PCC, and the SCC is utilized to increase the data throughput. For example: the RRC connection is only handled by the PCC.

5G NR mainly uses two frequency bands: frequency range 1 (FR1) band and frequency range 2 (FR2). The frequency range of the FR1 band is 450 MHz to 6 GHZ, also known as the sub 6 GHz band; the frequency range of the FR2 band is 24.25 GHz to 52.6 GHz, commonly referred to as millimeter wave (mmWave). The FR1 contains many frequency bands, in which some bands are FDD and some bands are TDD. In this way, there are CA between FDD and FDD frequency bands, CA between FDD and TDD frequency bands, and CA between TDD and TDD frequency bands within the FR1 band.

### Aspects Related to Optimizations for Periodic PHR for UL-CA

As noted above, in 5G NR with UL-CA, there are certain potential challenges for accurate PH value reporting. For example, if the PHR is reported only on a PCC uplink slot that is not overlapped with an SCC uplink slot (a “1-CC slot”), the SCCs reported PH value may always be a virtual PHR. This virtual PHR may have a PH value greater than zero and, thus, may prevent triggering a CP-OFDM to DFT-s-OFDM waveform switch and the resulting reduction in PAPR.

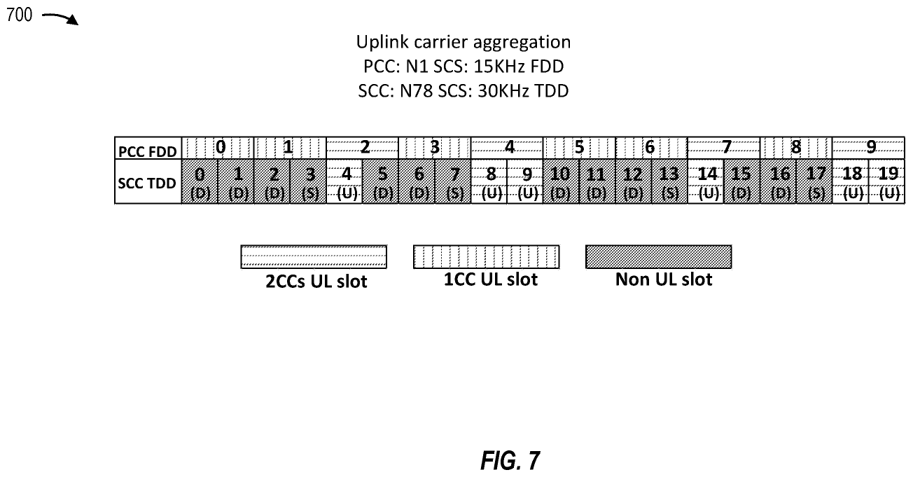

FIG. 7 depicts an example about CA 700 between the PCC FDD (N1 band) with 15 KHz SCS and the SCC TDD (N78 band) with 30 KHz SCS that illustrates the difference between 1-CC slots and 2-CC slots. In the illustrated example, the SCC slot occasions occur less often than the PCC UL slot occasions.

As a result, the majority of the slots are 1-CC slots, where uplink PCC and uplink SCC slots do not overlap. There are only a few 2-CC uplink slots where uplink PCC and uplink SCC slots overlap (slot 2 in the PCC and slot 4 in the SCC, slot 4 in the PCC and slots 8-9 in the SCC, etc.).

A PHR for one CC may be transmitted on another CC. All PHR reports may be transmitted together in the same MAC control element (CE) in the same subframe on the same CC. This CC may be any CC for which the UE has PUSCH resources granted. For example, assuming the PHR report is transmitted on the PCC for simplicity, a virtual (greater than-zero) PH value may always be reported for the SCC. This may prohibit the network from triggering energy saving operation in the UE such as PUSCH CP-OFDM to DFT-s-OFDM waveform switch.

Aspects of the present disclosure, however, provide techniques that may help accurately report PHR in such scenarios, by waiting for a 2-CC slot, where PCC and SCC uplink slots overlap. Waiting for a 2-CC slot, in this manner, may help avoid transmitting a virtual PHR (with PH value>0) for SCC, allowing the UE to provide a robust PHR without ambiguity to assist in decisions, such as waveform switching.

In other words, aspects of the present disclosure provide mechanisms for a UE to find an overlapped PCC/SCC slot, in order to report a real PHR, essentially converting what would have been reported as an SCC virtual PHR to a real PHR.

In some aspects, the UE needs to wait for a multi-CC uplink slot in order to transmit a periodic PHR to the NW that can ensure the PHR for two CCs are the real PHR that may trigger PUSCH CP (CP-OFDM) to DFT (DFT-s-OFDM) waveform switch.

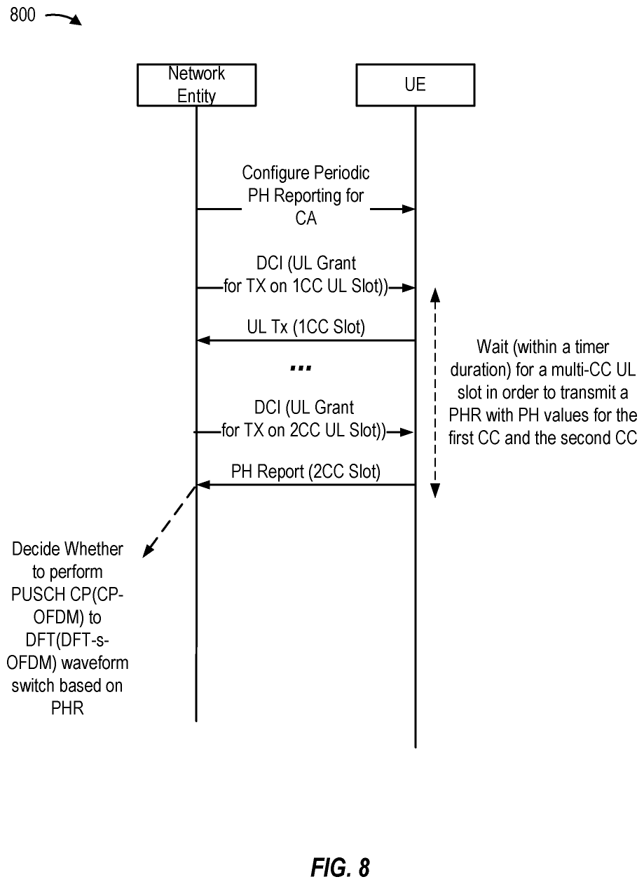

Techniques proposed herein may be understood with reference to the call flow diagram 800 of FIG. 8, which depicts an example of optimized periodic PHR reporting for ULCA, in accordance with aspects of the present disclosure.

As illustrated, the network entity (e.g., a gNB or component of a disaggregated base station) may configure the UE for periodic PH reporting for CA (e.g., via RRC configuration). As noted above, a PHR periodic timer (sl-phr-Periodic Timer) may be initiated that triggers PHR reporting when it expires.

As illustrated, in some cases, the UE may wait, within the timer duration) for a multi-CC (2-CC) uplink slot in order to transmit the PHR. Waiting for a 2-CC slot may help ensure that the PHR values for both CCs are real PH values, rather than virtual. As a result, rather than report a virtual (inaccurate) PH value for SCC, the UE may report a real PH value for SCC that may trigger PUSCH CP (CP-OFDM) to DFT (DFT-s-OFDM) waveform switch.

In some aspects, in order to find a multi-CC uplink slot in order to transmit a PHR with real PH values, the UE may activate a (separate) timer as noted above within the PHR periodic timer. While this timer is active, the UE may skip an uplink grant from DCI on a 1CC uplink slot. The 1CC uplink slot grant may be used by the UE for PUSCH data transmission.

When the UE receives a DCI with an uplink grant on a 2CC uplink slot (multi-CC uplink slot), before the time expires, the UE may send the PHR, with real values for both the first component carrier and the second component carrier. As illustrated, based on this PHR, the network entity may decide whether to perform PUSCH CP (CP-OFDM) to DFT (DFT-s-OFDM) waveform switch.

In some cases, a MAC entity at the UE may determine when to wait for a 2-CC slot according to a certain algorithm. For example, the algorithm may first determine if an SCC uplink scheduling rate is higher than a threshold x in a last duration of the PHR periodic timer (phr-PeriodicTimer), where x may be configurable (e.g., as 50%). If the SCC uplink scheduling rate is not higher than the threshold, the UE may perform the conventional PHR reporting procedure.

If the SCC uplink scheduling rate is higher than the threshold, the UE may then start (or restart) an occasion-timer value O at the timestamp occasion-timer for a prior phr-PeriodicTimer expiration, where O may also be configurable (e.g., as 10 ms). When the occasion-timer O is still running, if a new transmission new-Tx grant (e.g., a grant for a new uplink transmission as opposed to a retransmission) is on a 1CC only UL slot, the UE may choose to not use this UL grant for the PHR report and may, instead wait for the next new-Tx grant.

If the next new-Tx grant is on a 2-CC UL slot and if the DCI for this new-Tx grant on the non-PHR report CC is received later than the one on the PHR report CC, the UE may convert the virtual PHR to a real PHR. Otherwise, the UE may choose this UL grant for the PHR report

When the occasion-timer O expires, the UE may choose the first new-Tx grant UL slot for PHR report. In some cases, while the occasion-timer O running, if the SCC is deactivated or a virtual radio link failure (vRLF) is detected, the UE may stop and reset occasion-timer O to 0.

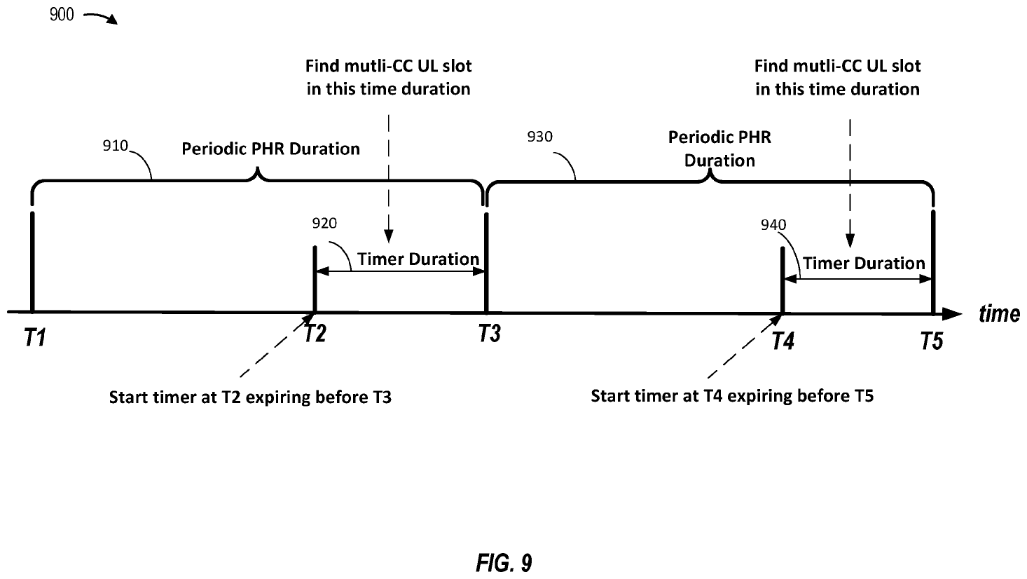

FIG. 9 illustrates an example of using such a timer in periodic PHR duration to find a multi-CC uplink slot, in accordance with certain aspects of the present disclosure. As noted above, the NW may configure periodic PH reporting for CA with a periodic PHR timer (sl-phr-Periodic Timer). The example shows two durations of the periodic PHR timer, 910 expiring at time T3 and 930 expiring at time T5. As illustrated, the UE may start a timer at T3, before expiration of the first PHR duration 910 and look for a new-TX grant on a multi-CC uplink slot (within duration 920) in order to transmit a PHR with PH values for the first CC and the second CC. Similarly, the UE may start the timer at T4, before expiration of the second PHR duration 930 and look for a new-TX grant on a multi-CC uplink slot (within duration 940) in order to transmit a PHR with PH values for the first CC and the second CC.

As noted above, assuming the two CCs are PCC and SCC, and the PHR is transmitted on the PCC for simplicity, the two timers 920 and 940 may be initiated within their corresponding periodic PHR timers 910 and 930 when a scheduling rate for uplink transmissions on the SCC is higher than a threshold in the previous PHR period. While the periodic timers 920 and 940 are running, the UE may wait for an uplink transmission grant for the multi-CC uplink slot in order to transmit the PHR and skipping an uplink slot scheduled by an uplink transmission grant, if that uplink slot is an uplink slot for only the PCC or the SCC.

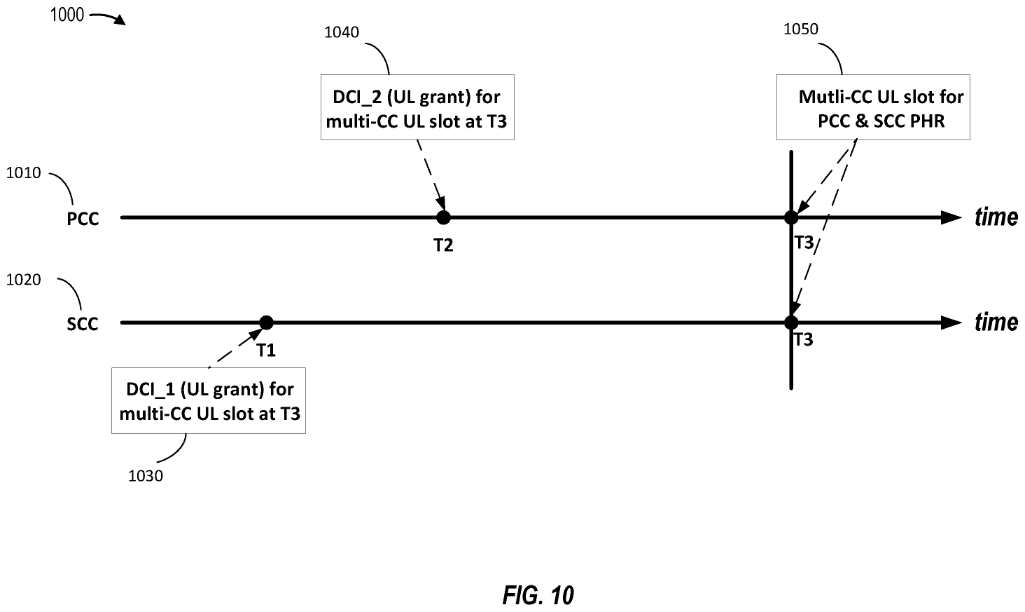

FIG. 10 illustrates a scenario where a virtual PHR is converted to a real PHR, in accordance with aspects of the present disclosure.

The example assumes the PHR for PCC 1010 and SCC 1020 is transmitted on PCC 1010. For example, during the timer duration (920 of FIG. 9), DCI_1 1030 and DCI_2 1040 with the uplink grant for a multi-CC uplink slot 1050 may be received by the SCC 1020 and the PCC 1010, respectively, at times T1 and T2.

A multi-CC uplink slot for the PCC 1010 and the SCC 1020 PHR is scheduled by DCI_1 1030 and DCI_2 1040 at time T3. In this case, since the DCI_1 1030 for the multi-CC uplink slot 1050 transmission grant for the SCC is received before the DCI_2 1040 for the multi-CC uplink slot 1050 transmission grant for the PCC, the PH values for the PCC 1010 and the SCC 1020 PHR are all real, and their PHR may be transmitted together on the multi-CC uplink slot at time T3.

In some cases, however, if the DCI_1 1030 for the multi-CC uplink slot 1050 transmission grant for the SCC 1020 is received after the DCI_2 1040 for the multi-CC uplink slot 1050 transmission grant for the PCC 1010, the PH value of the PHR for the SCC is virtual that may be converted into a real PH value, which may be included in the transmitted PHR for the PCC 1010 and the SCC 1020.

In some aspects, if the timer 920 expires without finding a multi-CC uplink slot 1050 in order to transmit the PCC 1010 and the SCC 1020 PHR, the UE may select an uplink slot scheduled by a next new uplink transmission grant for transmitting the PCC and SCC PHR. As noted above, if the SCC is deactivated or there is a vRLF on the SCC, the UE may reset the timer 920.

As described above, aspects of the present provide enhancements for sending periodic PHR on (2-CC) UL slots where PCC and SCC uplink slots overlap, with real PHR values for PCC and SCC. The techniques may, thus, better assist the network in making waveform switching decisions, based on PHR, in ULCA scenarios. Reporting PHR in this manner, when the UE has UL transmissions on both PCC and SCC, may help enable more accurate power estimation at the network side (e.g., by the gNB) when compared to conventional approaches to report PHR when the UE has UL transmission only on one CC.

### Example Operations of a User Equipment

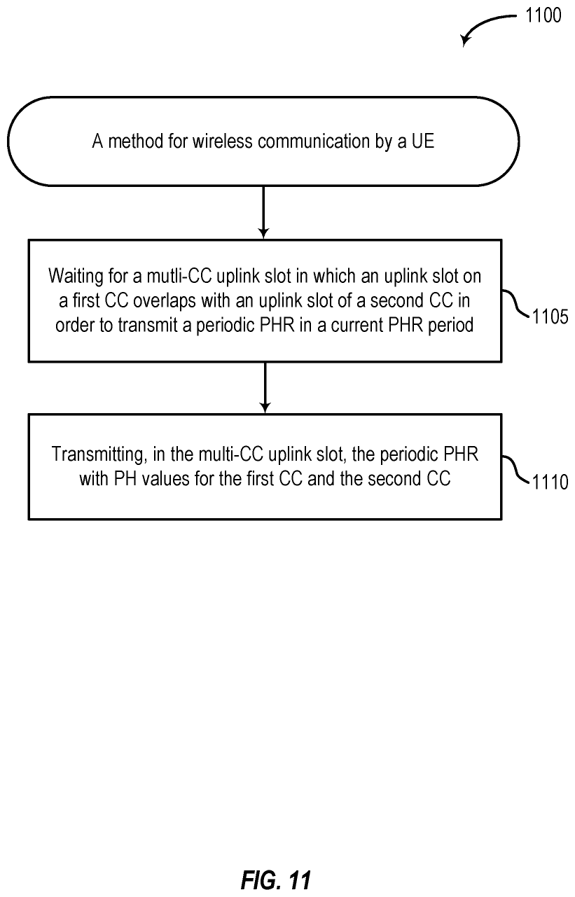

FIG. 11 shows a method 1100 for wireless communications by a UE, such as UE 104 of FIGS. 1 and 3.

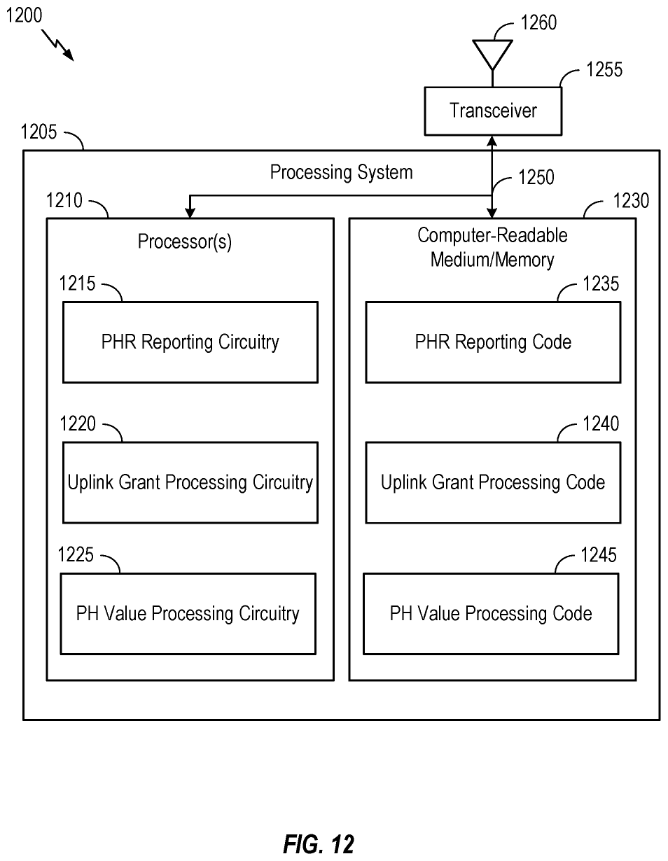

Method 1100 begins at 1105 with waiting for a multi-CC uplink slot in which an uplink slot on a first CC overlaps with an uplink slot of a second CC in order to transmit a periodic PHR in a current PHR period. In some cases, the operations of this step refer to, or may be performed by, periodic PHR reporting circuitry as described with reference to FIG. 12.

Method 1100 then proceeds to step 1110 with transmitting, in the multi-CC uplink slot, the periodic PHR with PH values for the first CC and the second CC. In some cases, the operations of this step refer to, or may be performed by, periodic PHR reporting circuitry as described with reference to FIG. 12.

Various aspects relate to the method 1100, including the following aspects.

In some aspects, the first CC comprises a PCC and the second CC comprises a SCC; or the first CC comprises an SCC and the second CC comprises a PCC. In some aspects, the UE waits for the multi-CC uplink slot in order to transmit the PHR when a scheduling rate for uplink transmissions on the SCC, in a previous PHR period, is higher than a threshold.

In some aspects, method 1100 further includes initiating a timer within the current PHR period. In some aspects, method 1100 further includes waiting for an uplink transmission grant for the multi-CC uplink slot in order to transmit the PHR, while the timer is running. In some aspects, the uplink transmission grant comprises a grant for an initial uplink transmission. In some aspects, a duration of the timer is defined by a timestamp when the timer is initiated and a periodic PHR timer expiration timestamp.

In some aspects, waiting for the first uplink slot in order to transmit the PHR, while the timer is running, comprises: skipping an uplink slot scheduled by an uplink transmission grant, if that uplink slot is an uplink slot for only one of the first or second CCs.

In some aspects, if a first DCI for an uplink transmission grant for the first CC is received before a second DCI for an uplink transmission grant for the second CC, method 1100 further includes: converting a virtual PH value for the second CC to a real PH value; and including the converted real PH value in the transmitted PHR.

In some aspects, if the timer expires without finding a multi-CC uplink slot in order to transmit the PHR, method 1100 further includes selecting an uplink slot scheduled by a next uplink transmission grant for transmitting the PHR.

In some aspects, the first CC comprises a PCC and the second CC comprises a SCC; and method 1100 further includes resetting the timer if the SCC is deactivated or a vRLF is detected on the SCC.

In one aspect, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative steps are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to the transceiver 1255 (e.g., a transmitter and/or a receiver). The transceiver 1255 is configured to transmit and receive signals for the communications device 1200 via the antenna 1260, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code) that when executed by the one or more processors 1210, cause the one or more processors 1210 to perform the method 1100 described with respect to FIG. 11, or any aspect related to it. Note that reference to a processor performing a function of communications device 1200 may include one or more processors 1210 performing that function of communications device 1200.

In the depicted example, computer-readable medium/memory 1230 stores code (e.g., executable instructions), such as periodic PHR reporting code 1235, uplink grant processing code 1240, and PH value processing code 1245. Processing of the periodic PHR reporting code 1235, uplink grant processing code 1240, and PH value processing code 1245 may cause the communications device 1200 to perform the method 1100 described with respect to FIG. 11, or any aspect related to it.

The one or more processors 1210 include circuitry configured to implement (e.g., execute) the code stored in the computer-readable medium/memory 1230, including circuitry such as periodic PHR reporting circuitry 1215, uplink grant processing circuitry 1220, and PH value processing circuitry 1225. Processing with periodic PHR reporting circuitry 1215, uplink grant processing circuitry 1220, and PH value processing circuitry 1225 may cause the communications device 1200 to perform the method 1100 described with respect to FIG. 11, or any aspect related to it.

Various components of the communications device 1200 may provide means for performing the method 1100 described with respect to FIG. 11, or any aspect related to it. For example, means for transmitting, sending or outputting for transmission may include transceivers 354 and/or antenna(s) 352 of the UE 104 illustrated in FIG. 3 and/or the transceiver 1255 and the antenna 1260 of the communications device 1200 in FIG. 12. Means for receiving or obtaining may include transceivers 354 and/or antenna(s) 352 of the UE 104 illustrated in FIG. 3 and/or the transceiver 1255 and the antenna 1260 of the communications device 1200 in FIG. 12.

According to some aspects, periodic PHR reporting circuitry 1215 waits for a multi-CC uplink slot in which an uplink slot on a first CC overlaps with an uplink slot of a second CC in order to transmit a periodic PHR in a current PHR period. In some examples, periodic PHR reporting circuitry 1215 transmits, in the multi-CC uplink slot, the periodic PHR with PH values for the first CC and the second CC.

In some aspects, the first CC comprises a PCC and the second CC comprises a SCC; or the first CC comprises an SCC and the second CC comprises a PCC. In some aspects, the UE waits for the multi-CC uplink slot in order to transmit the PHR when a scheduling rate for uplink transmissions on the SCC, in a previous PHR period, is higher than a threshold.

According to some aspects, uplink grant processing circuitry 1220 initiates a timer within the current PHR period. In some examples, uplink grant processing circuitry 1220 waits for an uplink transmission grant for the multi-CC uplink slot in order to transmit the PHR, while the timer is running. In some aspects, the uplink transmission grant comprises a grant for an initial uplink transmission. In some aspects, a duration of the timer is defined by a timestamp when the timer is initiated and a periodic PHR timer expiration timestamp. In some aspects, waiting for the first uplink slot in order to transmit the PHR, while the timer is running, comprises: skipping an uplink slot scheduled by an uplink transmission grant, if that uplink slot is an uplink slot for only one of the first or second CCs.

According to some aspects, if a first DCI for an uplink transmission grant for the first CC is received before a second DCI for an uplink transmission grant for the second CC: PH value processing circuitry 1225 converts a virtual PH value for the second CC to a real PH value; and PHR reporting circuitry 1215 includes the converted real PH value in the transmitted PHR.

In some examples, if the timer expires without finding a multi-CC uplink slot in order to transmit the PHR, PHR reporting circuitry 1215 selects an uplink slot scheduled by a next uplink transmission grant for transmitting the PHR.

In some aspects, the first CC comprises a PCC and the second CC comprises a SCC, and uplink grant processing circuitry 1220 resets the timer if the SCC is deactivated or a vRLF is detected on the SCC.

### Example Clauses

Implementation examples are described in the following numbered clauses:
Clause 1: A method for wireless communications by a UE, comprising: waiting for a multi-CC uplink slot in which an uplink slot on a first CC overlaps with an uplink slot of a second CC in order to transmit a periodic PHR in a current PHR period; and transmitting, in the multi-CC uplink slot, the periodic PHR with PH values for the first CC and the second CC.
Clause 2: The method of Clause 1, wherein: the first CC comprises a PCC and the second CC comprises a SCC; or the first CC comprises an SCC and the second CC comprises a PCC.
Clause 3: The method of Clause 2, wherein the UE waits for the multi-CC uplink slot in order to transmit the PHR when a scheduling rate for uplink transmissions on the SCC, in a previous PHR period, is higher than a threshold.
Clause 4: The method of any one of Clauses 1-3, further comprising: initiating a timer within the current PHR period; and waiting for an uplink transmission grant for the multi-CC uplink slot in order to transmit the PHR, while the timer is running.
Clause 5: The method of Clause 4, wherein the uplink transmission grant comprises a grant for an initial uplink transmission.
Clause 6: The method of Clause 4, wherein a duration of the timer is defined by a timestamp when the timer is initiated and a periodic PHR timer expiration timestamp.
Clause 7: The method of Clause 4, wherein waiting for the first uplink slot in order to transmit the PHR, while the timer is running, comprises: skipping an uplink slot scheduled by an uplink transmission grant, if that uplink slot is an uplink slot for only one of the first or second CCs.
Clause 8: The method of Clause 4, further comprising, if a first DCI for an uplink transmission grant for the first CC is received before a second DCI for an uplink transmission grant for the second CC: converting a virtual PH value for the second CC to a real PH value; and including the converted real PH value in the transmitted PHR.
Clause 9: The method of Clause 4, further comprising, if the timer expires without finding a multi-CC uplink slot in order to transmit the PHR, selecting an uplink slot scheduled by a next uplink transmission grant for transmitting the PHR.
Clause 10: The method of Clause 4, wherein: the first CC comprises a PCC and the second CC comprises a SCC; and the method further comprises resetting the timer if the SCC is deactivated or a vRLF is detected on the SCC.
Clause 11: A processing system, comprising: a memory comprising computer-executable instructions; one or more processors configured to execute the computer-executable instructions and cause the processing system to perform a method in accordance with any one of Clauses 1-10.
Clause 12: A processing system, comprising means for performing a method in accordance with any one of Clauses 1-10.
Clause 13: A non-transitory computer-readable medium comprising computer-executable instructions that, when executed by one or more processors of a processing system, cause the processing system to perform a method in accordance with any one of Clauses 1-10.
Clause 14: A computer program product embodied on a computer-readable storage medium comprising code for performing a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications by a user equipment (UE), comprising:
waiting for a multiple component carrier (multi-CC) uplink slot in which an uplink slot on a first component carrier (CC) overlaps with an uplink slot of a second CC in order to transmit a periodic power headroom report (PHR) in a current PHR period; and
transmitting, in the multi-CC uplink slot, the periodic PHR with power headroom (PH) values for the first CC and the second CC.

2. The method of claim 1, wherein:
the first CC comprises a primary CC (PCC) and the second CC comprises a secondary CC (SCC); or
the first CC comprises an SCC and the second CC comprises a PCC.

3. The method of claim 2, wherein the UE waits for the multi-CC uplink slot in order to transmit the PHR when a scheduling rate for uplink transmissions on the SCC, in a previous PHR period, is higher than a threshold.

4. The method of claim 1, further comprising:
initiating a timer within the current PHR period; and
waiting for an uplink transmission grant for the multi-CC uplink slot in order to transmit the PHR, while the timer is running.

5. The method of claim 4, wherein the uplink transmission grant comprises a grant for an initial uplink transmission.

6. The method of claim 4, wherein a duration of the timer is defined by a timestamp when the timer is initiated and a periodic PHR timer expiration timestamp.

7. The method of claim 4, wherein waiting for the first uplink slot in order to transmit the PHR, while the timer is running, comprises:
skipping an uplink slot scheduled by an uplink transmission grant, if that uplink slot is an uplink slot for only one of the first or second CCs.

8. The method of claim 4, further comprising, if a first downlink control information (DCI) for an uplink transmission grant for the first CC is received before a second DCI for an uplink transmission grant for the second CC:
converting a virtual PH value for the second CC to a real PH value; and
including the converted real PH value in the transmitted PHR.

9. The method of claim 4, further comprising, if the timer expires without finding a multi-CC uplink slot in order to transmit the PHR, selecting an uplink slot scheduled by a next uplink transmission grant for transmitting the PHR.

10. The method of claim 4, wherein:
the first CC comprises a primary CC (PCC) and the second CC comprises a secondary CC (SCC); and
the method further comprises resetting the timer if the SCC is deactivated or a virtual radio link failure (vRLF) is detected on the SCC.

11. (canceled)

12. (canceled)

13. (canceled)

14. (canceled)

15. An apparatus for wireless communications at a user equipment (UE), comprising: at least one memory comprising instructions; and one or more processors configured to execute the instructions and cause the UE to:
wait for a multiple component carrier (multi-CC) uplink slot in which an uplink slot on a first component carrier (CC) overlaps with an uplink slot of a second CC in order to transmit a periodic power headroom report (PHR) in a current PHR period; and
transmit, in the multi-CC uplink slot, the periodic PHR with power headroom (PH) values for the first CC and the second CC.

16. The apparatus of claim 15, wherein:
the first CC comprises a primary CC (PCC) and the second CC comprises a secondary CC (SCC); or
the first CC comprises an SCC and the second CC comprises a PCC.

17. The apparatus of claim 16, wherein the UE waits for the multi-CC uplink slot in order to transmit the PHR when a scheduling rate for uplink transmissions on the SCC, in a previous PHR period, is higher than a threshold.

18. The apparatus of claim 15, wherein the one or more processors are further configured to execute the instructions and cause the UE to:
initiate a timer within the current PHR period; and
wait for an uplink transmission grant for the multi-CC uplink slot in order to transmit the PHR, while the timer is running.

19. The apparatus of claim 18, wherein the uplink transmission grant comprises a grant for an initial uplink transmission.

20. The apparatus of claim 18, wherein a duration of the timer is defined by a timestamp when the timer is initiated and a periodic PHR timer expiration timestamp.

21. The apparatus of claim 18, wherein waiting for the first uplink slot in order to transmit the PHR, while the timer is running, comprises:
skipping an uplink slot scheduled by an uplink transmission grant, if that uplink slot is an uplink slot for only one of the first or second CCs.

22. The apparatus of claim 18, wherein the one or more processors are further configured to execute the instructions and cause the UE to, if a first downlink control information (DCI) for an uplink transmission grant for the first CC is received before a second DCI for an uplink transmission grant for the second CC:
convert a virtual PH value for the second CC to a real PH value; and
include the converted real PH value in the transmitted PHR.

23. The apparatus of claim 18, wherein the one or more processors are further configured to execute the instructions and cause the UE to, if the timer expires without finding a multi-CC uplink slot in order to transmit the PHR, select an uplink slot scheduled by a next uplink transmission grant for transmitting the PHR.

24. An apparatus for wireless communications at a user equipment (UE), comprising:
means for waiting for a multiple component carrier (multi-CC) uplink slot in which an uplink slot on a first component carrier (CC) overlaps with an uplink slot of a second CC in order to transmit a periodic power headroom report (PHR) in a current PHR period; and
means for transmitting, in the multi-CC uplink slot, the periodic PHR with power headroom (PH) values for the first CC and the second CC.
